(19) United States
(12) Patent Application Publication
(10) Pub. No.: US 2015/0273259 A1
(43) Pub. Date: Oct. 1, 2015

(54) Complex method for cleaning environment from oil pollutants

(71) Applicant: UAB "BIOCENTRAS", Vilnius (LT)

(72) Inventors: Saulius Grigiskis, Vilnius (LT); Vilma Cipinyte, Vilnius (LT); Julius Vaitoska, Vilnius (LT); Jolante Aikaite-StanaItiene, Vilnius (LT); Indre Gailiute, Vilnius (LT); Grazina Rackauskiene, Vilnius (LT); Fortunatas Grygas, Vilnius (LT)

(21) Appl. No.: 14/438,282

(22) PCT Filed: Mar. 4, 2014
(86) PCT No.: PCT/IB2014/059426

§ 371 Date: Apr. 24, 2015

(30) Foreign Application Priority Data
Oct. 14, 2013 (LT) 2013-115

(51) Int. Cl. A62D 3/02; C02F 3/02; C02F 3/32; B09C 1/10; C02F 3/34

(52) U.S. Cl. CPC A62D 3/02; B09C 1/10; B09C 1/105; C02F 3/344; C02F 3/327; C02F 3/02; A62D 2101/20

(57) ABSTRACT

The present invention relates to the area of environmental biotechnology. It describes environment object cleaning from oil pollutants (OPs), when they are treated with oil hydrocarbon emulsifying and oxidizing bacterial preparations and plants suitable for phytoremediation. This method is used for cleaning of soil, briny and fresh water. This invention presents a novel complex OP cleaning method, which fully or partially solves the present shortcomings with environment cleaning from OPs. Invention is different from other known oil pollutant cleaning methods, because OP cleaning is managed with a help from an expert system which comprises the evaluation of primary OP composition and environment parameters, selection of OP cleaning method and OP biodegrading microorganism blends, selection of optimal concentrations for these blends, selection of optimal OP separation and biodegradation parameters and selection of the most suitable plants for phytoremediation.

### TECHNICAL FIELD

This invention is attributed to the field of environment protection biotechnology. It describes the cleaning of environment objects from oil pollutants (OPs), i.e. their treatment with hydrocarbons emulsifying and oxidizing bacterial preparations, and phytoremediating plants. This method is used for the cleaning of soil, briny and fresh water.

### BACKGROUND OF INVENTION

One pollution type that is frequently encountered is pollution with oil and its products. Obtained oil is transported increasingly larger distances, thus heightening the chance of accidents; its use generates the exhaust of gasses responsible for “greenhouse effect”, which affects the ecological state of various regions. It has been determined that tanker accidents alone are responsible for the loss of approximately 1 million tones of oil products a year; ⅓ of those are light fractions that evaporate into the environment and the rest sink or are thrown onto the shore. Mud is created during oil purification, as the by-products are eliminated. They are mostly heavy oil hydrocarbon fractions absorbed into peat or soil. Additionally, large amounts of oil polluted and hard to clean water are generated. Immediately upon their entry into the environment, oil pollutants (OPs) are toxic to the biological sphere. There are lots of different oil products with various properties; their noxiousness to the environment is also not uniform. The most dangerous are volatile products able to quickly disperse in the surroundings; it may be gasoline, kerosene, diesel and other liquid products. Solid state oil products, e.g. bitumen, are only slightly or not at all dangerous to the environment, thus from now on only liquid state OPs will be discussed. Soil and water polluted with oil hydrocarbons are cleaned using physical, chemical and biological methods. However, sometimes a desirable result cannot be achieved by cleaning soil using a biological method, as seasonal temperature fluctuations and overly large OP concentrations in soil have an effect on oil pollutant oxidizing microorganisms. Phytoremediation method is applied increasingly widely, because this cleaning method requires less expenditure than other biological treatments. Polluted soil has to be additionally cleaned before applying phytoremediation, in order to lower OP concentrations to optimal for plant vegetation. A need for the optimization of cleaning treatments arises, as the work scale increases. Only the creation of new complex technologies and their optimal management in addition to the development and application of new biopreparations allows to solve the emerging problems.

Patent literature describes various microorganisms with oil oxidizing and surface active substance synthesizing properties. Singular oil oxidizing microorganisms (OOM) and their associations are used to clean soil and waters. Bacterial surface active substances (BSAS) and synthetic surface active substances (SSAS) are used for flushing out organic pollutants from the environment (water, soil) and for better biodegradation. Patents that describe OP removal using plants also exist.

Known OOMs used to clean environment from oil pollutants: Azotobacter vinelandii 21 strain, described in LT patent No. 3111 B, Pseudomonas fluorescens IGN 57, described in LT patent No. 4792 B, Candida lipolytica C. 6.1-5, described in LT patent No. 4793 B. The main shortcoming of using those microorganisms is that enzymes synthesized by singular strains are not enough to fully degrade compounds in OPs.

U.S. Pat. No. 6,652,752 B2 describes a cleaning method when OOMs are isolated from the environment and multiplied, then their mixed culture is used for cleaning of OP infused water and oily mud in a reactor. This method is suitable for use on oily mud when it is polluted with saturated and aromatic hydrocarbons, asphaltenes and resins. Better biodegradation is achieved by using nutrient additives, surface active substances, aeration and keeping an optimal pH. The drawbacks of this method are: it's hard to control an OP biodegradation process using an unidentified OOM culture; OP biodegradation can only be done ex situ.

There are known environment cleaning from OPs methods, where pure microorganism culture blends are used for biodegradation. For example, patent LT 5057 B describes a biopreparation composed of a mix of hydrophilic and lipophilic OOM, designed to clean soil and water polluted with oil and its products. The drawback of this biopreparation is that it is effective in a narrow temperature range and only in a presence of small concentrations of oil hydrocarbons.

Patent RU 2266958 describes OOM strains Zoogloea sp. 14H, Arthrobacter sp. 13H, Arthrobacter sp. 15H, Bacillus sp. 3H, Bacillus sp. 12 and an association using them as a basis, which are used to clean soil and waters polluted with oil hydrocarbons. Patent shows that the growth of these strains is uninhibited, when the concentration of oil and fuel oil is respectively 15 and 10%. However, these OOMs only fully degrade oil hydrocarbons, when their concentrations are low: 0.5-0.7% for oil and 0.4-0.5% for fuel oil.

U.S. Pat. No. 6,649,400 describes OOMs belonging to genera Acinetobacter, Pseudomonas, Alcaligenes, Flavobacterium and Moraxella. These OOM strains are used single and in combinations to clean the environment from heavy oil hydrocarbons.

U.S. Pat. No. 5,494,580 describes a method of cleaning hydrocarbon polluted environment using microorganisms and their blends that are chosen according to the OP composition and quantity and environmental characteristics. Microorganisms Azotobacter vinelandii 21, Pseudomonas sp 0.9, Pseudomonas sp. 19, Pseudomonas sp. 31 and Acinetobacter calcoaceticus 23 are used for the degradation of hydrocarbons. The drawback of this patent relates to the long duration of degradation for heavy oil hydrocarbons.

Patent US 2009/0325271 describes a method of cleaning soil polluted with oil and its products, when the first stage uses oil emulsifying microorganism (OEM) strains Pseudomonas aeruginosa IOCX and Pseudomonas aeruginosa IOCX DHT, which separate OPs from the soil particles. OOM strains Pseudomonas putida IOC5a1, Pseudomonas putida IOCR1 and Baccilus subtilis were applied at least a fortnight later than OEM. The drawback of this patent is the absence of clarification for the application of OEMs and OOMs in various OP concentrations in the soil, and it is not known what OPs are being removed.

The method of removing oil hydrocarbons from the soil using higher plants and OOMs is also described. For example, patent US 2004/0101945 describes a method of removing poly-aromatic compounds from the environment using a system made of at least one suitable host-plant, which emits enzymes degrading organic pollutants into the environment, and one microorganism able to degrade organic compounds, improve host-plant viability, growth and survivability. Recommended microorganisms are Burkholderia ATCC No. PTA-4755, Burkholderia ATCC No. PTA-4756, Sphingomonas ATCC No. PTA-4757. The drawback of this patent is the limited application for the soil cleaning from OPs, since there are not much poly-aromatic compounds in oil and its products.

Patent LT 4593 describes a method for cleaning soil from OPs that is suitable to use in the finishing stage of the biological treatment, when the soil is treated with organic and mineral fertilizers and seeded with less demanding agricultural plant cultures resistant to oil products, whose rhizosphere immobilizes oil oxidizing microorganisms. Cultures are grown until soil pollution drops to the allowed level, and then the soil with the plant biomass is ploughed. The drawback of this patent is that the described method is only used at a low (6000-7000 mg/kg) concentration of oil products in soil.

Aforementioned OP treatment methods do not fully solve all the problems pertaining to the cleaning of environment from the pollutants generated during industrial processes:
advanced environment cleaning from OPs methods require human resources of high qualification;
there is no universal technology designed for the cleaning of different objects and territories from OPs;
there is no effective technology for cleaning of the environment from OPs in different climate conditions;
there are no solutions for cleaning the environment from old OPs;
there is no complex method based on the biotechnological processes that could solve the aforementioned problems;
there is no special systematic and effective environment cleaning from OPs management based on process control.

### SUMMARY OF THE INVENTION

Goal of invention is to remove the pollution with oil hydrocarbons from various environment objects and restore their original state by natural means, i.e. OEM and OOM based bioproducts, and plants for phytoremediation, without inducing the secondary pollution.

Essence of invention is a complex environment cleaning from OPs, based on biotechnological processes, and managed by a special expert system (ES) that chooses optimal cleaning technological parameters: blends of OEMs and OOMs, cleaning conditions and phytoremediating plants.

This invention offers a novel complex OP cleaning method, which fully or mostly solves shortcomings in the present environment cleaning from OPs. The invention is different from other known oil pollutant cleaning methods, as OP cleaning is controlled by ES, whose operation encompasses the evaluation of primary OP composition and environmental parameters, the selection of OP cleaning method and OP biodegrading microorganism blends, the selection of optimal concentrations for microorganisms composing those blends, the selection of OP separation and biodegradation parameters and the selection of suitable plants for phytoremediation.

The second difference is that environment objects polluted with oil hydrocarbons are cleaned with microorganism blends selected from OEM group consisting of Pseudomonas sp. NJ13, Acinetobacter sp. PR82, Acinetobacter sp. N3 and OOM group consisting of Acinetobacter sp. N3, Acinetobacter sp. NJ9, Acinetobacter NJ5; it encompasses the following stages:
a) evaluation of polluted environment and determination of quantity and composition of OPs;
b) OEM selection in order to increase bioaccessibility;
c) OOM selection in such a way that obtained biopreparations would function in wide ranges of oil hydrocarbon concentrations with various oil hydrocarbons at different environmental parameters: relief, temperature, humidity and atmospheric pressure;
d) contact of oil hydrocarbon polluted environment with OP biodegrading microorganism blends;
e) simultaneous OP separation and degradation, employing OEMs and OOMs;
f) application of phytoremediation for the removal of remaining OPs and restoration of soil properties.

The third difference is that biopreparation used in stage (b) can have properties of both OEM and OOM.

The fourth difference is that a complex OP cleaning method is used for the biodegradation of oil hydrocarbons characterized with different physical and chemical properties and structure.

The fifth difference is that using OEM and OOM blends on various environment objects with OP concentrations in range from maximal (˜100%) to minimal (˜0%), the best cleaning results were achieved at concentrations ranging from 35 to 0%.

As a sixth difference is that OP oxidizing microorganisms can be used in combination with SSAS.

As a seventh difference is that OP oxidizing microorganisms can be used in combination with BSAS.

The eighth difference is that water employed for washing OPs from soil can be used for the watering of the same soil, as remaining OPs are removed from it.

The ninth difference is that BSAS and SSAS can be used multiple times, constantly removing OPs before every use.

The tenth difference is displayed by observing live OEM cells in a bacterial SAS solution.

The eleventh difference is that OP emulsification is performed in a pH range of 6-11 and the temperature range of 20-90° C.

The twelfth difference is that OP degradation by OOM is performed in a pH range of 2-8.5 and the temperature range of 4-40° C., the most preferred pH is 7 and temperature is 30° C.

The thirteenth difference is that complex OP cleaning can be performed both in situ and ex situ.

The fourteenth difference is that complex OP cleaning can be started ex situ and continued in situ after the removal of a migrating OP fraction.

The fifteenth difference is that phytoremediation is employed after the environmental cleaning using OEM and OOM blends.

### BRIEF DESCRIPTION OF THE DRAWINGS

FIG. 1 Principal scheme of the OP removal process control

FIG. 2 Principal scheme of the preparation of OP emulsifying biopreparations

FIG. 3 Principal scheme of the preparation of OP oxidizing biopreparations

FIG. 4 Principal schemes of complex OP removal from water (a) and soil (b)

FIG. 5 Technological scheme of washing OPs from polluted soil

FIG. 6 Technological scheme of cleaning of water polluted with OPs

FIG. 7 Technological scheme of open type OP removal from soil

FIG. 8 Technological scheme of complex OP removal from soil by biodegradation

### DESCRIPTION OF PREFERRED EMBODIMENTS

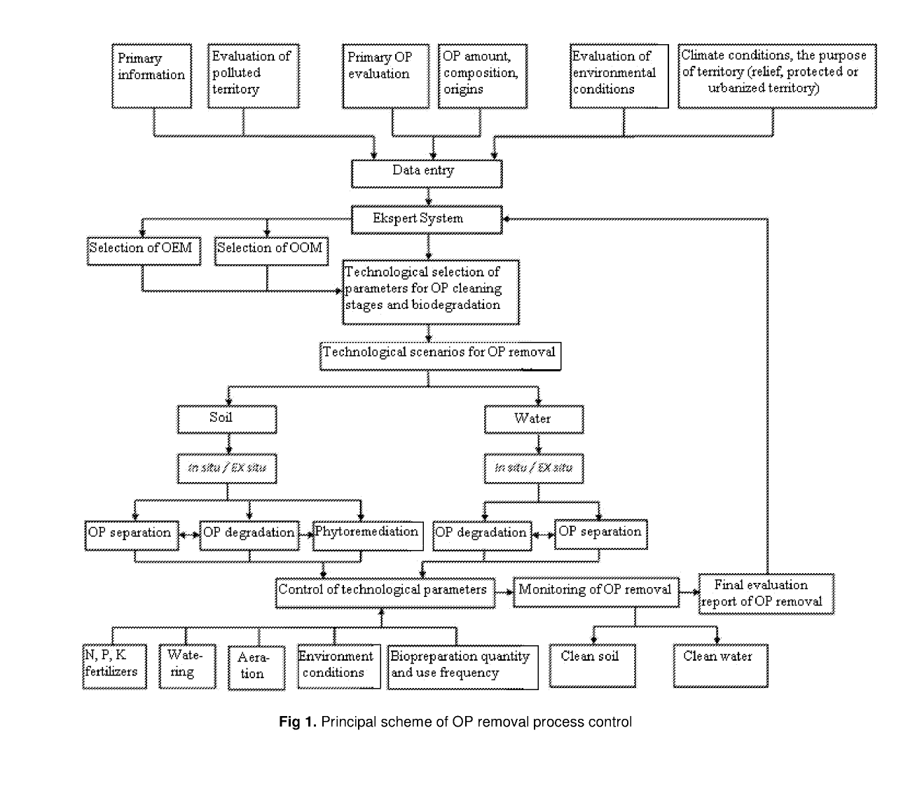

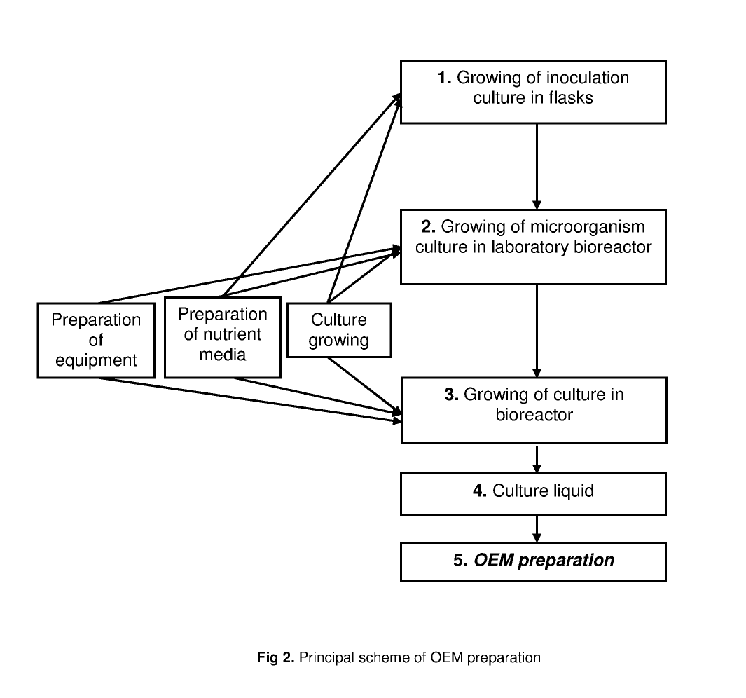

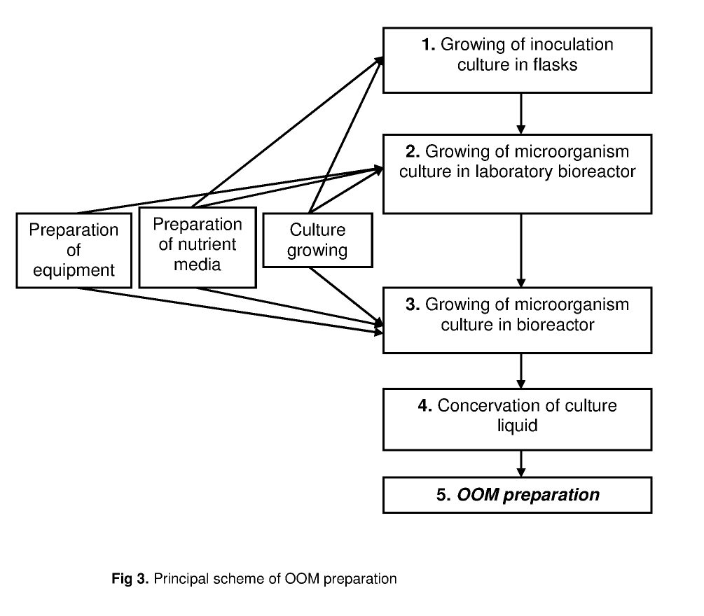

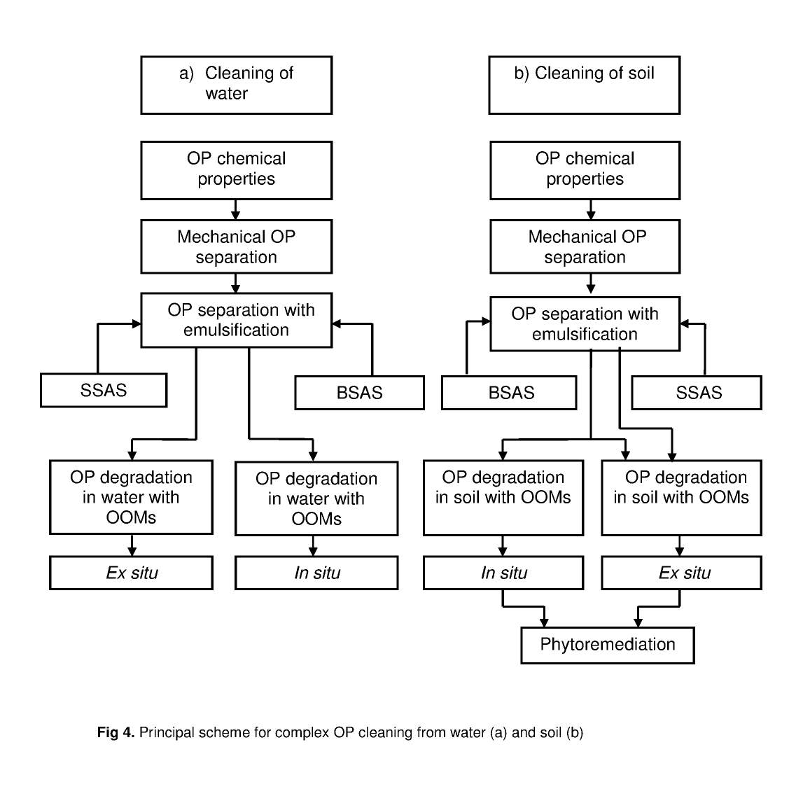

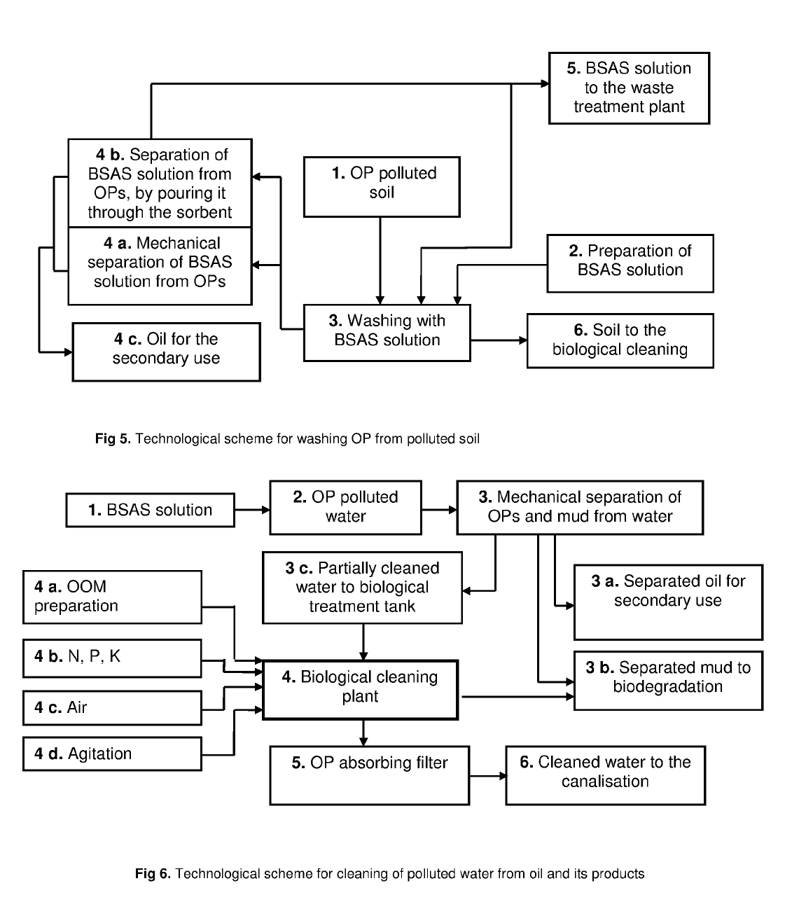

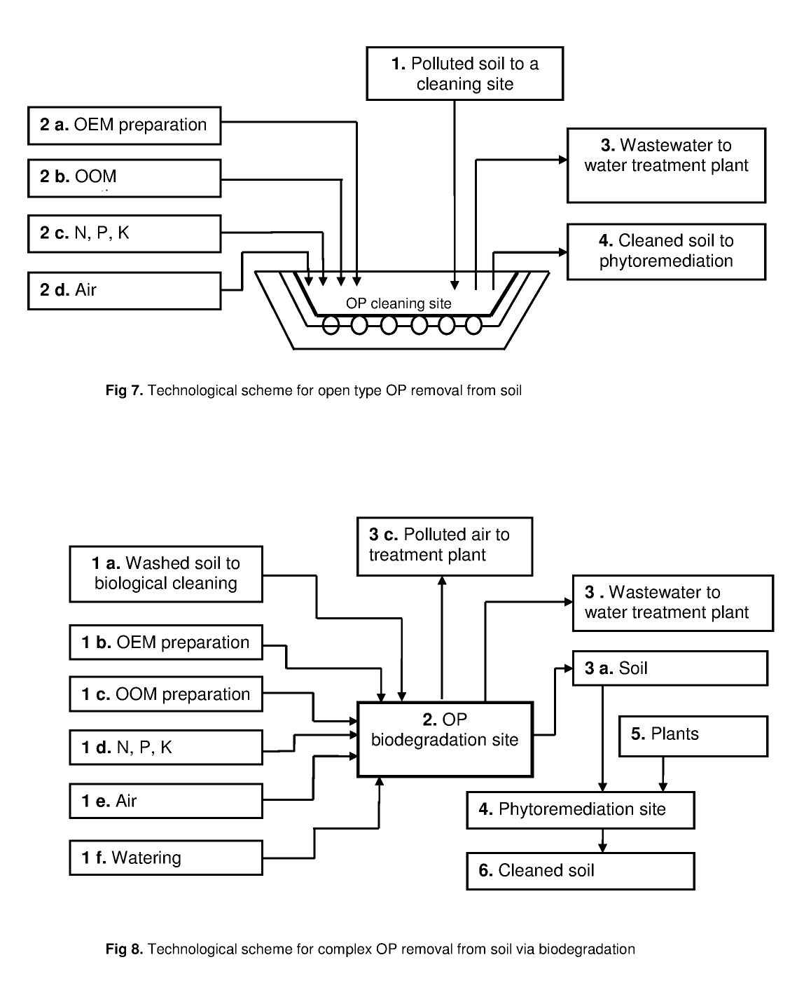

The process of OP removal from various environment objects is coordinated by ES (FIG. 1). The working of such a system is based on the collection and use of information from an OP spill and its application to control OP cleaning processes. Optimal territory cleaning from OP technological parameters are picked with the help of this system and OP removal scenario based on environment protection biotechnological methods is selected (prepared) using them as the foundation. Complex OP removal is performed by employing bioproducts, created using OEMs and OOMs as the basis, and phytoremediation by plants.

Microorganisms with the most prominent features of oil hydrocarbon emulsification and oxidation were chosen in order to create bioproducts with oil degrading properties.

Oil pollutants are best emulsified by Pseudomonas sp. NJ13, Acinetobacter sp. Pr82 and N3 microorganism strains. These strains are preserved in JSC “Biocentras” microorganism collection.

Their characteristics are as follows:

Pseudomonas sp. NJ13 strain (JSC “Biocentras” accession No. B-96-8N) was isolated from oil polluted water body near Nefteyugansk city in Tyumen Oblast (Russia).

Cells. Cells are in the form of rods with blunt ends, their size is 0.5-0.6Δ1.0-2.3 μm. Cells are mobile, rods can be seen either single or in pairs, Gram negative, do not form endospores.

Colonies. Glossy, cream-coloured, entire-margined, raised colonies with smooth surface and mucous consistence grow on solid medium after 24 hours.

Physiological-biochemical properties. It's an aerobe. Catalase and oxidase reactions are positive, it hydrolyses gelatine. Optimal conditions for strain growth are: temperature range is 25-30° C. and pH is 7.0. Uses glucose, oleic acid, diesel, oil, octadecane, starch, olive and sunflower oil, sodium acetate as a source of carbon and energy.

Based on 16S rDNA gene analysis, this microorganism is closest to genus Pseudomonas sp., as shown in SEQ ID No. 1.

Acinetobacter sp. PR82 strain (JSC “Biocentras” accession No. B-94-6N) was isolated from black-earth polluted with heavy oil products in Kaliningrad Oblast (Russia).

Cells. Cell form and size is dependent on culture age and growth conditions; can range from cocci (0.5-0.7 μm in diameter) to rods (0.6-0.8×1.2-1.6 μm size). Cells are not of even size in culture. Cells are mobile, Gram reaction is variable.

Colonies. 1-2 mm in diameter, glossy, opaque, raised colonies with smooth surface and whitish entire margin grow on solid medium after 24 hours.

Physiological-biochemical properties. It's an aerobe. Catalase reaction is positive, oksidase and urease reactions are negative. Culture is not resistant to acid. Optimal conditions for strain growth: temperature is 30-40° C. and pH is 4.5-9.0. It doesn't hydrolyse starch and gelatine. Uses glucose, fructose, galactose, saccharose, xylose, ethanol, acetate, citrate, L-alanine, L-phenylanine, D/L-arginine, some hydrocarbons, oil and its products, fats as a source of carbon and energy.

Based on 16S rDNA gene analysis, this microorganism is closest to genus Acinetobacter sp., as shown in SEQ ID No. 2.

Acinetobacter sp. N3 strain (JSC “Biocentras” accession No. B-92-11AA) was isolated in Norway from OP.

Cells. Cell form and size is dependent on culture age and growth conditions; can vary from cocci to straight and irregularly-shaped rods (0.6×2.0 μm size). Cells are mobile, mildly positive reaction with Gram dye, however aging culture cells become Gram-negative.

Colonies. 1-3 mm in diameter, glossy, whitish, smooth-surfaced, circular colonies grow on solid medium after 48 hours.

Physiological-biochemical properties. It's an aerobe. Optimal growth conditions: temperature range is 20-30° C., pH is 6.4-7.0. Oxidase reaction is negative, catalase reaction is positive. Uses xylose, galactose, fructose, acetate, L-alanine, D/L-arginine, Tween-80, some aromatic and aliphatic hydrocarbons, oil and oil products as a source of carbon and energy. It weakly assimilates glucose, doesn't hydrolyse gelatine, denitrification is negative, urease reaction is positive.

Based on 16S rDNA gene analysis, this microorganism is closest to genus Acinetobacter sp., as shown in SEQ ID No. 3.

OPs are best degraded by OOM Acinetobacter sp. NJ9, Acinetobacter sp. NJ5 strains. OP emulsifying Acinetobacter sp. N3 also displays such properties. These microorganism strains are deposited in JSC “Biocentras” microorganism collection. Their characteristics are:

Acinetobacter sp. NJ9 strain (JSC “Biocentras” accession No. B-96-2N) was isolated from oil polluted water body near Nefteyugansk city in Tyumen Oblast (Russia).

Cells. Single or paired cocci (0.5 μm) or rods (0.5×2.0 μm); rods can form a fake mycelium or be spread in a V or W formation. Gram dyeing is variable—culture is composed of Gram-positive and Gram-negative cells. Very clear cycle cocci-rods-cocci. Cells are mobile.

Colonies. 1-3 mm in diameter, glossy, raised, smooth-surfaced, translucent and fluorescent grey whitish colonies of paste consistence grow on solid medium after 48 hours.

Physiological-biochemical properties. It's an aerobe. Catalase reaction is positive, oxidase reaction is negative. Optimal growth conditions: temperature is 25-30° C., pH is 5.5-7.0. NJ9 strain hydrolyses starch, but doesn't hydrolyse cellulose and gelatine. Uses glucose, xylose, galactose, maltose, glycerin, ethanol, Tween-80, sodium acetate, L-alanine, some aliphatic and aromatic hydrocarbons, oil and its products as a source of carbon and energy.

Based on 16S rDNA gene analysis, this microorganism is closest to genus Acinetobactersp., as shown in SEQ ID No. 4.

Acinetobacter sp. NJ5 strain (JSC “Biocentras” accession No. B-96-1N) was isolated from oil polluted clay near Nefteyugansk city in Tyumen Oblast (Russia).

Cells. Culture is pleomorphic, evolution cycle (cocci-rods-cocci) depends on the medium composition, growth temperature and aeration. Diameter of cocci is 0.7-0.9 μm, rod size is 0.7-1.1×1.1-1.7 μm. Rods are mobile. Gram dyeing is variable—culture is composed of Gram-positive and Gram-negative cells.

Colonies. 2-4 mm in diameter, mildly glossy, raised, smooth-surfaced, whitish, entire-margined colonies of a paste consistence grow on solid medium after 48 hours.

Physiological-biochemical properties. It's an aerobe. Catalase reaction is positive, oxidaze, methyl red reactions and Voges-Proskauer test are negative. Not resistant to acid. Optimal growth conditions: temperature is 20-30° C. and pH is 7.0-7.5. Doesn't degrade cellulose, doesn't hydrolyse starch and gelatine. Uses glucose, xylose, galactose, lactose, L-alanine, some hydrocarbons, oil and its products, fats as a source of carbon and energy.

Based on 16S rDNA gene analysis, this microorganism is closest to genus Acinetobactersp., as shown in SEQ ID No. 5.

Evaluation of Polluted Environment Parameters, Determination of OP Chemical Origin and Quantity

After the introduction of OPs into the environment, firstly, according to the standard procedures, their chemical origin, quantity and polluted environment parameters are analyzed. Obtained data is transferred to the ES, whose activities encompass evaluation of primary OP composition and environment parameters, selection of OP removal method, selection of OEM and OOM blends, selection of optimal concentrations for the microorganisms in those blends, selection of optimal OP separation and biodegradation parameters and selection of the most suitable plants for the phytoremediation. With the help of the decision making process, main geographic, geologic, OP origin and quantity, climate, polluted environment characteristics and etc. data is processed and linked within ES module (Table 1).

ES also processes database information about material, logistic, and human resources needed for OP cleaning and evaluates financial expenditure and losses.

After primary evaluation of OP cleaning parameters, ES chooses biopreparation compositions and OP cleaning technological and biodegradation parameters.

TABLE 1
Principal example of environment evaluation ES module

| | | | Pollutant amount | | | | | | | | Pollutants | | | |
|---|---|---|---|---|---|---|---|---|---|---|---|---|---|---|
| | OP removal | OP removal | Up to | Up to | Up to | Up to | Up to | Up to | Up to | Up to | burned | | Pollutant type | |
| | in situ | ex situ | 1 t | 5 t | 10 t | 20 t | 50 t | 100 t | 10 000 t | 50 000 t | Yes | No | Gasoline | Diesel |
| City-town | A1 | A2 | A3 | A4 | A5 | A6 | A7 | A8 | A9 | A10 | A11 | A12 | A13 | A14 |
| Technological soil | B1 | B2 | B3 | B4 | B5 | B6 | B7 | B8 | B9 | B10 | B11 | B12 | B13 | B14 |
| Cultivated soil | C1 | C2 | C3 | C4 | C5 | C6 | C7 | C8 | C9 | C10 | C11 | C12 | C13 | C14 |
| Recreational zone | D1 | D2 | D3 | D4 | D5 | D6 | D7 | D8 | D9 | D10 | D11 | D12 | D13 | D14 |
| Preserve | E1 | E2 | E3 | E4 | E5 | E6 | E7 | E8 | E9 | E10 | E11 | E12 | E13 | E14 |
| Ocean | F1 | F2 | F3 | F4 | F5 | F6 | F7 | F8 | F9 | F10 | F11 | F12 | F13 | F14 |
| Sea | G1 | G2 | G3 | G4 | G5 | G6 | G7 | G8 | G9 | G10 | G11 | G12 | G13 | G14 |
| Sea shore | I1 | I2 | I3 | I4 | I5 | I6 | I7 | I8 | I9 | I10 | I11 | I12 | I13 | I14 |
| River | J1 | J2 | J3 | J4 | J5 | J6 | J7 | J8 | J9 | J10 | J11 | J12 | J13 | J14 |
| River shore | K1 | K2 | K3 | K4 | K5 | K6 | K7 | K8 | K9 | K10 | K11 | K12 | K13 | K14 |
| Technological | L1 | L2 | L3 | L4 | L5 | L6 | L7 | L8 | L9 | L10 | L11 | L12 | L13 | L14 |
| waters | | | | | | | | | | | | | | |

| | | | | | | | | | Type of polluted | | | | |
|---|---|---|---|---|---|---|---|---|---|---|---|---|---|
| | Pollutant type | | | | | | | | environment | | | | |
| | Crude | | Chemical | Climate | | | Humidity | | | | | Briny | Fresh |
| | oil | Other | composition | Cold | Moderate | Hot | Sufficient | Insufficient | Sand | Clay | Loam | water | water |
| City-town | A15 | A16 | A17 | A18 | A19 | A20 | A21 | A22 | A22 | A24 | A25 | A26 | 27 |
| Technological soil | B15 | B16 | B17 | B18 | B19 | B20 | B21 | B22 | B23 | B24 | B25 | B26 | B27 |
| Cultivated soil | C15 | C16 | C17 | C18 | C19 | C20 | C21 | C22 | C23 | C24 | C25 | C26 | C27 |
| Recreational zone | D15 | D16 | D17 | D18 | D19 | D20 | D21 | D22 | D23 | D24 | D25 | D26 | D27 |
| Preserve | E15 | E16 | E17 | E18 | E19 | E20 | E21 | E22 | E23 | E24 | E25 | E26 | E27 |
| Ocean | F15 | F16 | F17 | F18 | F19 | F20 | F21 | F22 | F23 | F24 | F25 | F26 | F27 |
| Sea | G15 | G16 | G17 | G18 | G19 | G20 | G21 | G22 | G23 | G24 | G25 | G26 | G27 |
| Sea shore | I15 | I16 | I17 | I18 | I19 | I20 | I21 | I22 | I23 | I24 | I25 | I26 | I27 |
| River | J15 | J16 | J17 | J18 | J19 | J20 | J21 | J22 | J23 | J24 | J25 | J26 | J27 |
| River shore | K15 | K16 | K17 | K18 | K19 | K20 | K21 | K22 | K23 | K24 | K25 | K26 | K27 |
| Technological | L15 | L16 | L17 | L18 | L19 | L20 | L21 | L22 | L23 | L24 | L25 | L26 | L27 |
| waters | | | | | | | | | | | | | |

OEM Evaluation

Soil, due its structural properties, can absorb OPs that enter it. Sorption capacity depends on the soil type and OP fractional composition. Thus BSAS are used in order to increase OOM bioaccessibility to OPs and in such way increase the degradation speed of oil hydrocarbons.

One of the most important properties of BSAS is the ability to decrease surface tension within the phase interface. OEM strains were grown separately in liquid nutrient media. Surface tension of an OEM culture liquid was measured with a tensiometer at a temperature of 21° C. after 16 hours of incubation (Table 2).

TABLE 2
The evaluation of BSAS producing microorganisms
according to surface tension

| | | Surface tension, |
|---|---|---|
| No. | Strain | mN/m |
| 1 | Acinetobacter sp. N3 | 32.7 |
| 2 | Acinetobacter sp. Pr82 | 34.0 |
| 3 | Pseudomonas sp. NJ13 | 24.8 |

OOM Evaluation According to the Degradation of Oil Hydrocarbons of Various Composition and Structure

OP composing hydrocarbons are divided into light (C₆-C₁₀), medium (C₁₀-C₂₈) and heavy (C₂₈-C₄₀) depending on the amount of carbon atoms in their molecules (Table 3).

TABLE 3
OP degradation with OOMs

| | | OP degradation, % (after 24 h) | | | | |
|---|---|---|---|---|---|---|
| | | | Distillation | Blend of heavy and | | |
| | | Crude | of medium | medium fraction | | Fuel |
| No. | Microorganisms | oil | fractions | distillations | Diesel | oil |
| 1 | Acinetobacter | 65.3 | 68.5 | 38.5 | 71 | 30.9 |
| | sp. N3 | | | | | |
| 2 | Acinetobacter | 46.8 | 52.5 | 40.9 | 56.2 | 20.9 |
| | sp. NJ5 | | | | | |
| 3 | Acinetobacter | 40.6 | 45.7 | 31.5 | 47.4 | 15.0 |
| | sp. NJ9 | | | | | |

Oil hydrocarbons of such structure are usually found in places of “aged pollution”.

Spatial structure also influences degradation degree of OP hydrocarbons

(Table 4).

TABLE 4
Degradation of heavy OPs with various
spatial structures using OOMs

| | | Degradation, % | | |
|---|---|---|---|---|
| | | Unbranched chain | Branched chain | Aromatic |
| | | hydrocarbons | hydrocarbons | hydrocarbons |
| | Micro- | after 48 h | after 48 h | after 72 h |
| No. | organisms | Hexatriacontane | Squalane | Pyrene |
| 1 | Acineto- | 30.1 | 30.9 | 14.3 |
| | bacter | | | |
| | sp. N3 | | | |
| 2 | Acineto- | 46.1 | 54.5 | 18.9 |
| | bacter | | | |
| | sp. NJ5 | | | |
| 3 | Acineto- | 34.0 | 43.6 | 10.1 |
| | bacter | | | |
| | sp. NJ9 | | | |

Degradation of OPs in Soil

An ability of singular OOMs to degrade OPs in various types of soil was determined (Table 5).

TABLE 5
Degradation of oil:fuel oil (1:1) mix by
singular OOMs in various types of soil

| | | Degradation, % (after 6 weeks) | | |
|---|---|---|---|---|
| No. | Microorganisms | Loam | Clay | Sand |
| 1 | Acinetobacter sp. N3 | 43.1 | 38.8 | 35.2 |
| 2 | Acinetobacter sp. NJ5 | 52.3 | 32.2 | 43.6 |
| 3 | Acinetobacter sp. NJ9 | 37.5 | 47.9 | 49.2 |

Degradation of OPs using OOM and OEM blends in various types of soil was also evaluated (Table 6).

TABLE 6
Degradation of oil:fuel oil (1:1) mix by OOM
and OEM blends in various types of soil

| | | Degradation, % (after 6 weeks) | | | | | | | | |
|---|---|---|---|---|---|---|---|---|---|---|
| | | Loam | | | Clay | | | Sand | | |
| | | OEM | | | OEM | | | OEM | | |
| No. | OOM | N3 | Pr82 | NJ13 | N3 | Pr82 | NJ13 | N3 | Pr82 | NJ13 |
| 1 | Acinetobacter | 56.1 | 49.5 | 50.8 | 51.6 | 46.0 | 53.3 | 55.6 | 60.0 | 47.3 |
| | sp. N3 | | | | | | | | | |
| 2 | Acinetobacter | 77.0 | 55.4 | 58.7 | 60.1 | 44.4 | 41.7 | 64.0 | 81.4 | 78.7 |
| | sp. NJ5 | | | | | | | | | |
| 3 | Acinetobacter | 56.5 | 44.7 | 51.9 | 50.8 | 55.3 | 60.8 | 72.1 | 64.9 | 52.4 |
| | sp. NJ9 | | | | | | | | | |

Degradation of OPs in Fresh Water

Degradation of OP in fresh water was performed using OOM cultures. All the microorganisms were more effective at degrading oil, instead of fuel oil (Table 7).

TABLE 7
Degradation of oil and fuel oil (1:1) by OOMs in fresh water

Degradation, % (after 3 days)
Fresh water

| No. | OOM | Oil | Fuel oil |
|---|---|---|---|
| 1 | Acinetobacter sp. N3 | 71.2 | 60.4 |
| 2 | Acinetobacter sp. NJ5 | 55.4 | 54.3 |
| 3 | Acinetobacter sp. NJ9 | 59.6 | 43.4 |

Degradation of OPs in Briny Water

Cleaning of briny water from OPs was also performed using OOM cultures (Table 8).

TABLE 8
Degradation of oil and fuel oil (1:1)
by OOMs in sea and ocean water

| | | Degradation, % (after 4 days) | | | |
|---|---|---|---|---|---|
| | Microorganisms | Sea 3.5‰ | | Ocean 35‰ | |
| No. | and their blends | Oil | Fuel oil | Oil | Fuel oil |
| 1 | Acinetobacter sp. N3 | 54.8 | 45.2 | 31.6 | 26.7 |
| 2 | Acinetobacter sp. NJ5 | 39.7 | 38.4 | 13.3 | 21.4 |
| 3 | Acinetobacter sp. NJ9 | 38.0 | 25.2 | 27.6 | 24.2 |

Selection of Biopreparation Composition

Aside from the primary cleaning data, the data regarding OEM and OOM abilities to remove OPs from various types of soil and from water of different salinity is also entered into ES. With the help of ES decision making management process, this data is evaluated and the results help to make a choice of the best OEM and OOM blends.

Selection of Plants for Phytoremediation

The stage of OP removal using hydrocarbon biodegrading OEM and OOM blends is finished once OP concentration in soil decreases to 25 g/kg.

Phytoremediation is used for remaining oil pollution. This process can employ singular plants like red clover (Trifolium pratense L.), Timothy-grass (Phleum pratense), perennial ryegrass (Lolium perenne) or their combinations.

OP cleaning process is finished when the concentration of oil hydrocarbons does not exceed environmental regulations. All the data is entered into ES.

Management of OP Cleaning-Process

ES chooses the most optimal OP removal technological scenario for a particular environmental object and controls OP removal progress by processing all the present and newly entered OP removal technological parameters. If OP removal progress does not satisfy a chosen scenario, it is immediately replaced with another, more suitable to reach a maximal degree of OP degradation.

When OP concentrations satisfy environmental regulations, ES frames a final OP removal report, evaluating not only OP removal process, but also its costs.

Complex Soil Cleaning from OPs In Situ

This data is entered into ES:
polluted area is 10 ha;
soil type is loam;
average soil temperature is 20° C.;
soil humidity is 20%;
soil pH is 7.2;
OP concentration in the soil is about 162 g/kg;
OP chemical composition: saturated compounds—68%, aromatic compounds—14%, resins—8%, asphaltenes—10%.

ES chose this OP removal technological scenario, after processing present and entered data:
OEM strain Pseudomonas sp. NJ13; NOM—Acinetobacter sp. N3;
OEM and OOM ratio in the blend is 1:2.
primary blend concentration in a work suspension is 2.7×10⁷ CFU/mL;
nutrient additives (N and P);
foreseeable cleaning duration is up to 18 months
foreseeable frequency for taking of control samples is 1 time/3 months.

ES chosen scenario foresees that soil phytoremediation with a combination of Timothy-grass (Phleum pratense) and ryegrass (Lolium perenne) seeds will be performed after OP concentration decreases to 25 g/kg. Once OP concentration in soil decreases to 2 g/kg, OP removal works are terminated and a final report regarding OP cleaning process and its costs is prepared.

Complex Soil Cleaning from OP Ex Situ

This data is entered into ES:
the amount of oily mud is 1400 t;
soil type is loam;
humidity of oily mud is 50%;
pH of oily mud is 6.8;
OP concentration in a mud is about 285 g/kg;
OP chemical composition: C₂₈-C₄₀ OPs—42.5%, other OP fractions—57.5%.

ES chose this OP removal technological scenario, after processing present and entered data:

1. OP emulsification.
OP separation in a washing device;
used OEM strain is Acinetobacter sp. Pr82;
OP separation temperature is 45-50° C.;
pH of emulsifying suspension is 8.5;
OP emulsification process is terminated when OP concentration decreases to 170 g/kg.

2. OP degradation.
OP biodegradation is performed in a specially constructed cleaning site;
spreading layer thickness is 0.4 m;
OOM strains: Acinetobacter sp. NJ5 and Acinetobacter sp. NJ9.
OOM ratio in a blend is 1:1;
primary blend concentration in a work suspension is 5×10⁷ CFU/mL;
nutrient additives (N and P);
OP degradation process is terminated when OP concentration decreases to 25 g/kg.

3. Phytoremediation.
soil restoration is performed in a special phytoremediation field;
soil spreading layer thickness is 0.2-0.3 m;
ploughing and cultivation
plants used for phytoremediation are red clovers (Trifolium pretense L.)
phytoremediation process is terminated when OP concentration decreases to 2 g/kg.

4. Final OP removal report.
data about OP removal process;
data about OP removal costs.

Complex Cleaning of Freshwater Body from OPs

This data is entered into ES:
polluted area of freshwater body is 1 km²;
average water temperature is 18° C.;
water pH is 7.1;
OP concentration on the surface of the water is about 0.5 g/L;
OP chemical composition: diesel.

ES chose this OP removal technological scenario, after processing present and entered data:
used OOM strains are Acinetobacter sp. N3, Acinetobacter sp. NJ9;
ratio in the blend is 2.5:1;
primary blend concentration in a work suspension is 1.8×10⁶ CFU/mL;
cleaning duration is up to 6 months;
foreseeable frequency of taking control samples is every 0.5 months;
treatment frequency is 1 time/month.

ES chosen scenario foresees that OP cleaning process will be terminated once OP concentration drops to 0.4 mg/L. After that a final report about OP cleaning process and its costs will be prepared.

Complex Cleaning of Briny Water from OPs

This data is entered into ES:
accident on an oil platform;
oil amount in the sea is 200 t;
oil amount on the shore is 5 t;
polluted sea area is 20 km²;
polluted shore length is 15 km;
water salinity is 8.5‰;
OP chemical composition: crude oil.

ES chose this OP removal technological scenario, after processing present and entered data:

1. Water cleaning.
used OOM strain is Acinetobacter sp. NJ9;
primary concentration in a work suspension is 1.1×10⁷ CFU/mL;
cleaning duration is 3 months;
foreseeable frequency of taking control samples is 2 times/month;
treatment frequency is 2 times/month.

2. Shore cleaning.
used OEM strain is Acinetobacter sp. N3 and OOM strain is Acinetobacter sp. NJ9;
ratio in a blend is 1:1;
primary concentration in the main suspension is 1.3×10⁷ CFU/mL;
dosing volume is 1 L/metre of shore length;
cleaning duration is 3 months;
foreseeable frequency of taking control samples is 2 times/month;
treatment frequency is no less than 1 time/month.

ES chosen scenario foresees that OP cleaning process will be terminated once OP concentration drops to 0.1 mg/L in water and 1 g/kg on the shore. After that a final report about OP cleaning process and its costs will be prepared.

Principal schemes for ES operation, OEM and OOM biosynthesis and technological schemes for main OP removal processes are presented further.

1. Complex oil pollutant (OP) removal method, using OP biodegrading microorganism blends (biopreparations) consisting of oil emulsifying microorganisms (OEM) and oil oxidizing microorganisms (OOM), characterized in that it comprises the following steps:
(a) evaluation of polluted environment and determination of OP composition and quantity;
(b) selection of microorganism blend chosen from OEMs (Pseudomonas sp. NJ13, Acinetobacter sp. PR82, Acinetobacter sp. N3) and OOMs (Acinetobacter sp. N3, Acinetobacter sp. NJ9, Acinetobacter sp. NJ5) in such a way that obtained preparations are active in a wide range of oil hydrocarbons concentrations of various chemical origin and in various environmental conditions: reliefs, natural areas, temperature, humidity and atmosphere pressure;
(c) OP separation with OEM;
(d) OP degradation with OOM;
e) use of water separated from OPs with bacterial surface active substances (BSAS) in the soil watering;
(f) phytoremediation for the cleaning of the remaining OPs.

2. Complex OP removal method according to claim 1, characterized in that a biopreparation used in step (b) is a blend of one OEM and at least one OOM.

3. Complex OP removal method according to claim 1, characterized in that OPs are oil hydrocarbons of various chemical origins: straight chains, branching chains, aromatic hydrocarbons and other OP compounds.

4. Complex OP removal method according to claim 1, characterized in that using OEM and OOM blends on different environment objects, OPs can be cleaned in the concentrations ranging between maximal (˜100%) and minimal (˜0%), however optimal cleaning is achieved in the range of 35 to 0%.

5. Complex OP removal method according to claim 1, characterized in that the synthetic surface active substances (SSAS) are used in a blend with OOM strains for OP emulsification and oxidation.

6. Complex OP removal method according to claim 1, characterized in that BSAS are used in a blend with OOM strains for OP emulsification and oxidation.

7. Complex OP removal method according to claim 1, characterized in that water used for washing OP out of soil can be used again for watering the same soil after the removal of remaining OPs.

8. Complex OP removal method according to claim 5, characterized in that the surface active substance (SAS) solutions of bacterial or synthetic origin can be used multiple times constantly removing OPs before reusing them.

9. Complex OP removal method according to claim 5, characterized in that SAS solution of bacterial origin has some live OEM cells in it.

10. Complex OP removal method according to claim 1, characterized in that OP emulsification is performed in a medium with pH in a range of 6-11 and temperature in a range of 20-90° C.

11. Complex OP removal method according to claim 1, characterized in that OP degradation with OOM is performed in a pH range of 2-8.5 and a temperature range of 4-40° C., most preferred when pH is 7 and temperature is 30° C.

12. Complex OP removal method according to claim 1, characterized in that the aforementioned OP removal is performed either in situ or ex situ.

13. Complex OP removal method according to claim 1, characterized in that OP removal can be started ex situ and can be continued in situ after the removal of a migrating OP fraction.

14. Complex OP removal method according to claim 1, characterized in that the phytoremediation is applied after the environmental cleaning from OPs using OEMs and OOMs.

15. Expert system, characterized in that it is used for complex OP removal method according to claim 1 and in that it comprises: evaluation of primary OP composition and environment parameters, selection of a cleaning method using OEMs, OOMs and their blends, selection of their concentrations, washing and biodegradation parameters, selection of plants for phytoremediation.


SEQUENCE LISTING (5 sequences)

SEQ ID NO: 1 - DNA, 844 bp, Pseudomonas sp NJ13
  misc_feature (0)...(0): 16s rDNA
ntcnagcgnnnnaagngagcttgctcctggattcagcggcggacgggtgagtaatgcctaggaatctgccggtagtgggggacaacgtttcgaaagnaacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactnntacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggtttgttaagttggatgtgaaatccccgggctcaacctgggaactgcatccaaaactggcaagctagagtatggtagagggtggtggaatttcctgtgtagcggtgaaatgcgtagatataggaaggaacaccagtggcgaaggcgaccacctggactgatactgacactgaggtgcgaagcgtggggagcaaacaggattagataccctgnnagtccacgccgtaaacgatgtcnactagccgttgggagccttgagctcttagtggcgcagctancgcattaagttgaccgcctggggagtanggccnnaaggntaanntcn

SEQ ID NO: 2 - DNA, 740 bp, Acinetobacter sp PR82
  misc_feature (0)...(0): 16S rDNA
nancgnnnngntggtgcttgcactatcacttagcggcggacgggtgagtaatgcttaggaatctgcctatnagtgnnggacaacatttcgnnnnnnnngctaataccgcatacgtcctacgggagaaagcaggggatcttcggaccttgcgctaatagatgagcctaagtcggattagctagttggtggggtaaaggcctaccanggcgacgatctgtnncgggtctgagannannntccgccacactgggactgagacaggcccagactcctacgggaggcagcagtggggaatattggacaatgggcggaagcctgatccagccatgccgcgtgtgtgaagaaggccttatggttgtaangcactttaagcgaggaggaggctactttagttaatacctagagatagtggacgttactcgcagaataagcaccggctaactctgtgccagcagccgcggtnatacagagggtgcaagcgttaatcggatttactgnncgtaaagnncgcgtaggcggctaattnagtcaaatgngaaatccccgagcttaacttgggaattgcnttcgatactgnttagctagagtgngnnanagnatggtagaattccnggtgtagcggnnaaatgngnagagatctggnnnnntacnganggnganggnnnnnnnnngnnntaannctgacgctgaaggnnngaannnntggngnnnnaannnnnnttannnnccctgnnagtcca

SEQ ID NO: 3 - DNA, 854 bp, Acinetobacter sp N3
  misc_feature (0)...(0): 16S rDNA
nannncnnnntnnnngcnnnnnntannnnnnncnnnggnngggtgngtgnngnntnncgtangncgtatgcgggattnnnnnccntttcgagatgttgtcccccactaataggcngattcctaagcattactnacncgtnngccgctnngngntagtgcaagcnccntcnccnngctcgacttgcntnngntaagcctgccgccnncgttcnntcngnnncntggtcaaactnnnnnnnncgccaaanngggactgagacacggcccagantnnnacgggaggcagcagtggggaatattggacaatggggggaaccctgatccagccatgccgcgtgtgtgaagaaggccttatggttgtaaagcactttaagcgaggaggaggctcttttggttaatacccaagatgagtggacgttactcgcagaataagcaccggctaactctgtgccagcagccgcggtaatacagagggtgcaagcgttaatcggatttactgggcgtanagcgcgcgtaggcggccaattaagtcaaatgtgaaatccccgagcttaacttggnaattgcattcgatactggttggctagagtgtggnagaggnngnnagaattccaggtgtagcgntgaaatgcntagagatctggaggaataccgatggcgaaggcagccatctggcctancactgacgctgaggtgcgaaagcatgnngagcaaacaggattagataccctggtagtccatgccgtaaacgatgtctactagccgttggngcctttgaggctttagtgncgcagctaacgcgatannnagacngnntggngngtacggtcgcaagactaaaactcnnnnnnntt

SEQ ID NO: 4 - DNA, 873 bp, Acinetobacter sp NJ9
  misc_feature (0)...(0): 16S rDNA
ncangtcnnncggannngaggngnttgcaccttatcttagcggcggacgggtgagtaatgcttaggaatctgccatttagtgggggacaacattccgaaaggaatgctaataccgcatacgtcctacgggagaaagcaggggatcttcggaccttgcgctaaatgatgagcctaagtcggattagctagttggtggggtaaaggcctaccaaggcgacgatctgtagcgggtctgagaggatgatccgccacactgggactgagacacggcccagactcctacgggaggcagcagtggggaatattggacaatgggcggaagcctgatccagccatgccgcgtgtgtgaagaaggccttttggttgtaaagcactttaagcgaggaggaggctactagtactaatactactggatagtggacgttactcgcagaataagcaccggctaactctgtgccagcagccgcggtaatacagagggtgcgagcgttaatcggatttactgggcgtaaagcgtgcgtaggcggctttttaagtcggatgtgaaatccccgagcttaacttgggaattgcattcgatactgggaagctagagtatgggagaggatggtagaattccaggtgtagcggtgaaatgcgtagagatctggaggaataccgatggcgaaggcagccatctggcctaatactgacgctgaggtacgaaagcatggggagcaaacaggattagataccctggtagtccatgccgtaaacgatgtctactagccgttggggcctttgaggctttagtggcncagctnacnnnanaagnanaccgccnggngnagnnnngncgnaagantnaaannnnnnnnnnnnnnnnnnnnnnng

SEQ ID NO: 5 - DNA, 854 bp, Acinetobacter sp NJ5
  misc_feature (0)...(0): 16S rDNA
ncatgcaagtcgagcggngtgnnggtgcttgcactatcacttagcggcggacgggtgagtaatgcttaggaatctgcctattagtgggggacaacatttcgaaaggaatgctaataccgcatacgtcctacgggagaaagcaggggatcttcggaccttgcgctaatagatgagcctaagtcggattagctagttggtggggtaaaggcctaccaaggcgacgatctgtagcgggtctgagaggatgatccgccacactgggactgagacacggcccagactcctacgggaggcagcagtggggaatattggacaatgggcggaagcctgatccagccatgccgcgtgtgtgaagaaggccttatggttgtaaagcactttaagcgaggaggaggctactttagttaatacctagagatagtggacgttactcgcagaataagcaccggctaactctgtgccagcagccgcggtaatacagagggtgcaagcgttaatcggatttactgggcgtaaagcgcgcgtaggcggctaattaagtcaaatgtgaaatccccgagcttaacttgggaattgcattcgatactggttagctagagtgtgggagaggatggtagaattccaggtgtagcggtgaaatgcgtagagatctggaggaataccgatggcgaaggnagccatctggcnnnacactgacgctgangtgngaaancatggggagnaaacaggattagataccctggtagtccatgccgtaaacgatgnctacnagccgttggggcctttgnngctttagtggnnnnancnnnnnnnnnnnnnnaccnncnnggnannanngncngnannantaannt